(19) United States
(12) Patent Application Publication
(10) Pub. No.: US 2022/0334861 A1
(43) Pub. Date: Oct. 20, 2022

(54) SELF-ASSEMBLY AND SELF-OPTIMIZATION OF VIRTUAL NETWORK FUNCTIONS

(71) Applicant: AT&T Intellectual Property I, L.P., Atlanta, GA (US)

(72) Inventors: Mohammad Nikain, Atlanta, GA (US); Daniel Connolly, Suwanee, GA (US)

(21) Appl. No.: 17/234,208

(22) Filed: Apr. 19, 2021

(51) Int. Cl. G06F 9/455; H04L 12/24; H04L 12/46; H04L 29/08

(52) U.S. Cl. CPC G06F 9/45558; H04L 41/12; H04L 12/4641; H04L 41/0893; H04L 67/16; G06F 2009/4557; G06F 2009/45595

(57) ABSTRACT

A method includes receiving an indication of an origin node and a destination node for a service and receiving an indication of a plurality of paths from the origin node to the destination node. The method further includes receiving an indication of one or more functions used for the service and determining one or more nodes of the plurality of nodes that can operate or generate the one or more functions used for the service. The method further includes determining one or more operational positions for each of the one or more functions on one or more nodes of the plurality of nodes and providing instructions to generate or operate the one or more functions on the one or more operational positions. The method further includes sending messages for the service from the origin node to the destination node through an optimal path comprising the one or more operational positions.

### TECHNICAL FIELD

This disclosure is directed to a system and method for configuration of virtual network functions. More particularly, the disclosure relates to a method, system, and computer program for intent-based self-configuration of virtual network functions.

### BACKGROUND

Communication networks have migrated from using specialized networking equipment executing on dedicated hardware, like routers, firewalls, and gateways, to software defined networks (SDNs) executing as virtualized network functions (VNF) in a cloud infrastructure. To provide a service, a set of VNFs may be instantiated on general-purpose hardware. Each VNF may require one or more virtual machines (VMs) to be instantiated. In turn, VMs may require various resources, such as memory, virtual central processing units (vCPUs), and network interfaces or network interface cards (NICs).

Due to the growing number of VNFs and the fact that multiple vendors create VNFs, configuring universal customer premise equipment (uCPE) can be very complicated. Currently, these configurations are handled through a set of supported templates, each handling a fixed potential configuration. If a change is required, then either a transition plan between two specific templates must be available or the device has to be reset and loaded with a new template (potentially requiring service interruptions and additional reconfigurations). As the number of VNFs grow, the number of potential templates grows exponentially to support different ways the VNFs could be interconnected and also adds numerous transition plans among templates. The complexity of supporting such a large number of templates and transition plans is already nearing a breaking point and is sure to get worse with additional VNFs entering the market and more complex needs being required by the clients.

This background information is provided to reveal information believed by the applicant to be of possible relevance. No admission is necessarily intended, nor should be construed, that any of the preceding information constitutes prior art.

### SUMMARY

The present disclosure is directed to a device having a processor and a memory coupled with the processor. The processor effectuates operations including receiving an indication of an origin node and a destination node for a service. The processor further effectuates operations including receiving an indication of a plurality of paths from the origin node to the destination node, wherein the plurality of paths comprise a plurality of nodes. The processor further effectuates operations including receiving an indication of one or more functions used for the service. The processor further effectuates operations including determining one or more nodes of the plurality of nodes that can operate or generate the one or more functions used for the service. The processor further effectuates operations including determining one or more operational positions for each of the one or more functions on one or more nodes of the plurality of nodes. The processor further effectuates operations including providing instructions to generate or operate the one or more functions on the one or more operational positions. The processor further effectuates operations including sending messages for the service from the origin node to the destination node through an optimal path comprising the one or more operational positions.

The present disclosure is directed to a computer-implemented method. The computer-implemented method includes receiving an indication of an origin node and a destination node for a service. The computer-implemented method further includes receiving an indication of a plurality of paths from the origin node to the destination node, wherein the plurality of paths comprise a plurality of nodes. The computer-implemented method further includes receiving an indication of one or more functions used for the service. The computer-implemented method further includes determining one or more nodes of the plurality of nodes that can operate or generate the one or more functions used for the service. The computer-implemented method further includes determining one or more operational positions for each of the one or more functions on one or more nodes of the plurality of nodes. The computer-implemented method further includes providing instructions to generate or operate the one or more functions on the one or more operational positions. The computer-implemented method further includes sending messages for the service from the origin node to the destination node through an optimal path comprising the one or more operational positions.

The present disclosure is directed to a computer-readable storage medium storing executable instructions that when executed by a computing device cause said computing device to effectuate operations including receiving an indication of an origin node and a destination node for a service. Operations further include receiving an indication of a plurality of paths from the origin node to the destination node, wherein the plurality of paths comprise a plurality of nodes. Operations further include receiving an indication of one or more functions used for the service. Operations further include determining one or more nodes of the plurality of nodes that can operate or generate the one or more functions used for the service. Operations further include determining one or more operational positions for each of the one or more functions on one or more nodes of the plurality of nodes. Operations further include providing instructions to generate or operate the one or more functions on the one or more operational positions. Operations further include sending messages for the service from the origin node to the destination node through an optimal path comprising the one or more operational positions.

### BRIEF DESCRIPTION OF THE DRAWINGS

Aspects of the herein described telecommunications network and systems and methods are described more fully with reference to the accompanying drawings, which provide examples. In the following description, for purposes of explanation, numerous specific details are set forth in order to provide an understanding of the variations in implementing the disclosed technology. However, the instant disclosure may take many different forms and should not be construed as limited to the examples set forth herein. Where practical, like numbers refer to like elements throughout.

FIG. 1 is a block diagram of an exemplary operating environment in accordance with the present disclosure;

FIG. 2A is a block diagram illustrating a media and communication network in accordance with the present disclosure;

FIG. 2B is a block diagram illustrating a media and communication network in accordance with the present disclosure;

FIG. 3A is a flowchart of an exemplary method of operation in accordance with the present disclosure;

FIG. 3B is a flowchart of an exemplary method of operation in accordance with the present disclosure;

FIG. 4 is a schematic of an exemplary network device;

FIG. 5 depicts an exemplary communication system that provide wireless telecommunication services over wireless communication networks with which edge computing node may communicate;

FIG. 6 depicts an exemplary communication system that provide wireless telecommunication services over wireless communication networks with which edge computing node may communicate;

FIG. 7 is a diagram of an exemplary telecommunications system in which the disclosed methods and processes may be implemented with which edge computing node may communicate;

FIG. 8 is an example system diagram of a radio access network and a core network with which edge computing node may communicate;

FIG. 9 depicts an overall block diagram of an example packet-based mobile cellular network environment, such as a general packet radio service (GPRS) network, with which edge computing node may communicate;

FIG. 10 illustrates an exemplary architecture of a GPRS network with which edge computing node may communicate; and

FIG. 11 is a block diagram of an exemplary public land mobile network (PLMN) with which edge computing node may communicate.

### DETAILED DESCRIPTION

5G, multi-access edge computing (MEC), streaming services, and other high bandwidth services are growing in popularity. These technologies and services require a telecommunications network to rapidly expand and reoptimize. Planning and engineering in order to utilize the technologies and services involve in network expansion and optimization, which can take a lot of time, even with the advent of virtual network functions (VNFs) running on cloud nodes (e.g., network cloud nodes (NECs)). In addition, planning and engineering of VNFs is typically manual due to the lack of a scalable technique for VNFs to configure and install themselves in the network.

Currently, network cloud (NC), NEC, and MEC nodes with a network are typically small in number. The placement and optimization of VNFs used in conjunction with NCs, NECs, or MECs, may also be handled through a manual process (e.g. planning and engineering) similar to physical equipment (e.g., routers, etc.). Because VNFs can be deployed quickly, an analysis of network traffic patterns, availability of resources (e.g. NEC or NC nodes), assessment of impacts due to optimization, or an automated way to install, turnup, or configure the VNFs, is needed. The analysis may be used to automatically determine potential solutions, analyze an impact of each solution, and select an optimum configuration.

As a complexity of the network grows (e.g., O(n2)) due to the increase in use of NCs, NECs, MECs, and VNFs in the network, optimizing VNF placement in NCs or NECs becomes more difficult. Optimizations are further impacted any time VNFs are updated or when new VNFs are introduced into the network. Accordingly, current techniques for optimization and placements of VNFs occur using an arduous process including input from expert network engineers. This process often leads to human errors resulting in a network that is far from optimized.

Hence, current techniques for optimization and placements of VNFs are inefficient because errors due to manual optimization often increases network operations cost and causes failures in response increases in demand. Moreover, re-optimization of VNFs is often not considered due to the complexity in determining an optimization. Accordingly, providing a system that can reduce lead times for network reconfiguration and optimization, allows the network to rapidly reconfigure VNFs to meet the demand for content related to new technologies such as 5G, IoT, streaming, VR, etc.), and saves underutilized network resources would be beneficial. Optimization criteria may be predetermined and may include delay and traffic impact, but can include other things such as cost. Delay may include the network user (client/customer) experiences on the data path (less hops and higher capacity paths usually translates to low delay). Traffic impact may include the aggregate load on the network based on where certain VNFs are located. If aa VNF is allocated closer to the majority of its client, then the data flowing to/from that VNF from/to the client may go over less links and hence cause less traffic in the network than when the VNF is placed farther from the client. Note that delay and traffic impact tend to be related (more hops, means bad for both), but not always due to the types of links involved.

Other factors such as cost can come into play (e.g., certain data centers are cheaper to run in a rural area vs. densely populated area). So, we can consider the optimization based on a set of parameters, and then normalize them to cost or monetary metric. For example, delay in milli-seconds can be translated into a monetary metric by saying the network operator can charge more money for a service with lower delay (hence some conversion factor). Traffic can be more directly converted (e.g., cost of having sufficient capacity), etc.

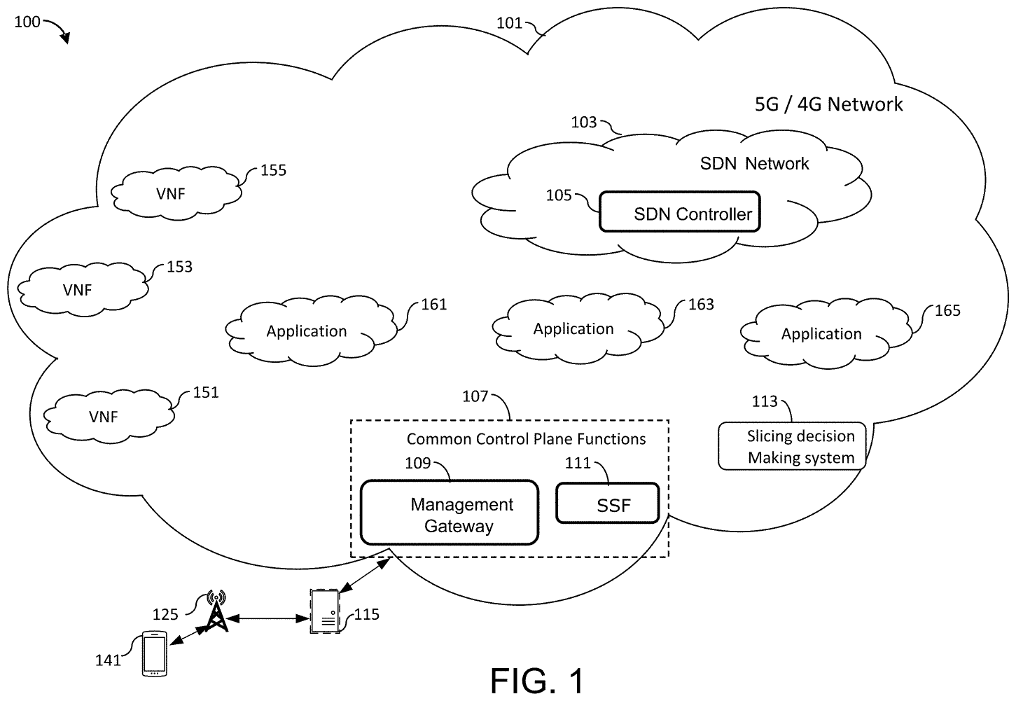

Illustrated in FIG. 1 is an exemplary communication network 100 which provides access to network resources according to examples of the present disclosure. A communication network 101 includes a software defined network (SDN), SDN network 103. The SDN network 103 may be controlled by one or more SDN controllers. For example, the SDN network 103 may include an SDN controller 105. The SDN controller 105 may be a computing system executing computer executable instructions or modules to provide various functions. In one or more examples, multiple computer systems or processors may provide the functionality illustrated and described herein with respect to the SDN controller 105. The SDN controller 105 may include various components or can be provided via cooperation of various network devices or components. For example, SDN controller 105 may include or have access to various network components or resources, such as a network resource controller, network resource autonomous controller, a service resource controller, a service control interpreter, adapters, application programming interfaces, compilers, network data collection engine, or analytics engine (not shown). The SDN controller 105 may also include access information describing available resources or network information, such as network objects statistics, events, alarms, topology, or state changes. The SDN controller 105 may use, generate, or access system configurations, including configuration of resources available to the SDN controller 105 for providing access to services.

The communication network 101 may be provided with common control plane functions 107 that include a management gateway such as MGW 109 or a slice selection function (SSF), such as SSF 111. The MGW 109 may capture traffic entering the communication network 101 from various communication devices (e.g., mobile devices 141) that enters the communication network 101 via one or more multi-access edge computing (MEC) devices (e.g., MEC 115) and one or more air interfaces (e.g., radio access network (RAN) 125). Note with regard to slicing operations consider each slice a network in which optimization done (divide the network to slices based on some criteria (not related to this invention). Then optimize within each slice using the disclosed subject matter, or, as stated, select which slice to use for the VNF, again using the disclosed subject matter.

The MGW 109 may communicate with the SDN network 103 through SDN controller 105 regarding traffic entering the communication network 100. The MGW 109 and the SDN controller 105 may communicate via an OpenFlow protocol. The MGW 109 may inform the SDN controller 105 of information regarding services sought by one or more communication devices, which may serve as an endpoint. The SDN Controller 105 is an application in a software-defined network that manages flow control to enable intelligent networking. The SDN controller 105 may allow servers to tell switches where to send packets. The SDN controller 105 may also analyze requested services to determine the service functions and or network data flows that would be required to facilitate delivery of the services to the communication devices.

The SSF 111 may be responsible for selecting the appropriate slice per user utilizing, for example, 5G RAN 129. The SSF 111 may include a network interface for receiving indications of triggering events and for transmitting instructions, a processor, and a non-transient memory for storing instructions. The instructions, upon execution by the processor, cause the SSF 111 to select a second slice as a target slice; and to initiate a migration of the mobile device to the selected target slice in response to a slice reselection triggering event associated with a communication device. In some instances, a slice reselection triggering event may occur when there is a change in the service requirements of the communication device.

The slicing decision making system 113 may determine the appropriate slice based on certain criteria (e.g., a built-in policy or set of policies). The criteria may be related to the type of customer, the service area, needed coverage for special events, the user equipment and the services being requested (e.g., service agreements that are tied to locations).

The SDN controller 105 may query a service layer to determine what specific network functions are required to facilitate the requested service or services. The SDN controller 105 may also analyze policies for the requested service or services. The policies may include network engineering rules, which can be defined by a network designer, engineer, business unit, operations personnel, or the like, or a subscriber policy, which can be defined during ordering of the service. Subscriber policies can include, for example, service level agreements (“SLAs”), location restrictions (e.g., locations at which the services are allowed or not allowed), bandwidth ranges, time restrictions (e.g., times of day, days of week, or other times at which the service is allowed or not allowed), security restrictions or policies, or the like.

The SDN Controller 105 may facilitate distribution of VNF elements (e.g., VNF 151, VNF 153, or VNF 155) to proper clouds based on service requirements. The SDN Controller 105 may determine service functions and network data path routings required to provide services to one or more devices. The SDN Controller 105 may determine a set of VNFs that may provide the services and may instantiate this set of VNFs into the communication network 101, based on the service function and network data path analysis, such that “slices” of the communication network 101 are placed in network locations that provide advantages in terms of dedicates services, shortened network paths, lower latency, or ease of access to devices or data for the communication devices that are using the services. The SDN Controller 105 may also monitor the instantiated VNFs for network resources levels and modify these VNFs, as needed, to insure optimal performance.

The communications device may establish wireless communications with RAN 125 to start a communication session. The communications device may utilize a portal to start the session. The portal may be a function of an application residing on the communications device as a standalone application or as a client application to a server application (e.g., application 161, application 163, or application 165) of the network 100. The portal functionality enables the communications device to request particular service features either directly or indirectly. Accordingly, the communications device may use the portal to generate a service request. The service request may include service feature data indicating service features desired or needed for a service being created and/or instantiated via the SDN controller 105. Alternatively, the service request can be a bare request for access to a service. In this case, the SDN controller 105 may determine the nature of the service and the functionality and resources required for providing the service.

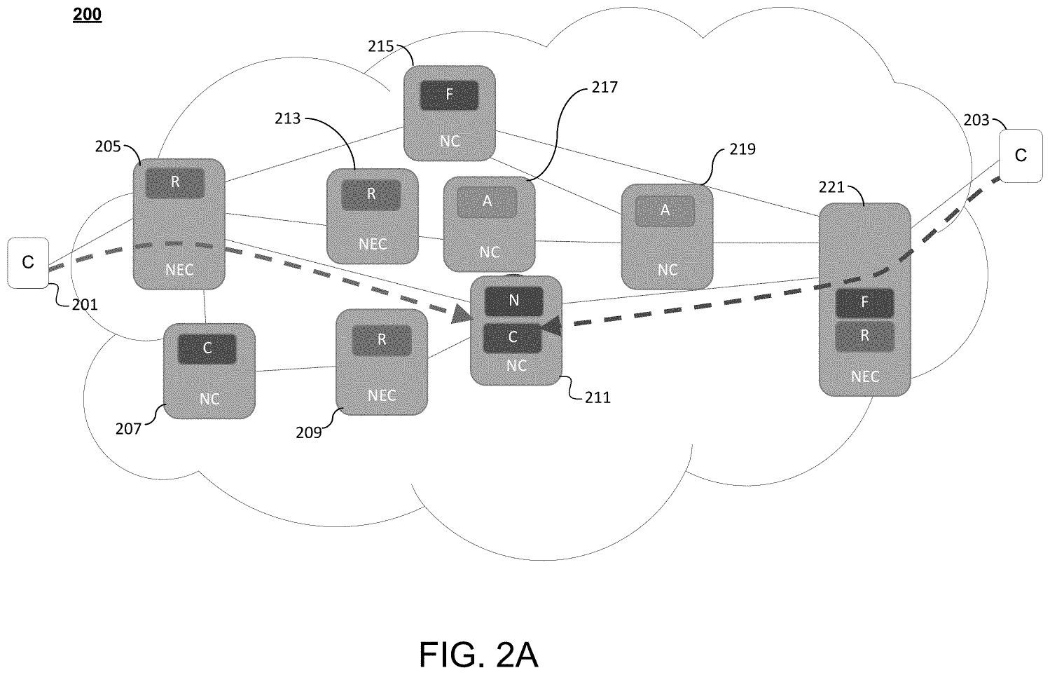

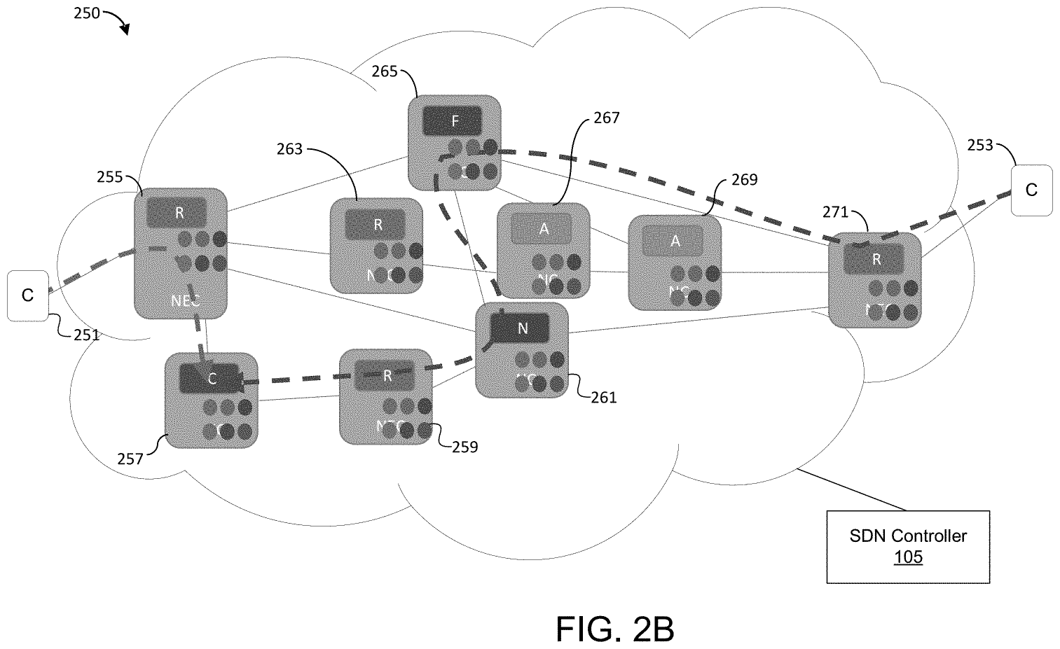

FIG. 2A is a block diagram 200 illustrating connecting two or more clients via a communication network in which multiple VNFs reside on one or more nodes according embodiments of the present disclosure. A first client 201 may connect to a destination (e.g., second client 203) via a network (e.g., network 100) having a plurality of nodes (e.g., Network Cloud (NC) nodes or Network Edge Cloud (NEC) nodes. NEC nodes (e.g., NEC node 205, NEC node 209, NEC node 213, and NEC node 221) and NC nodes (e.g., NC node 207, NC node 215, NC node 211, NC node 217, and NC node 219) may each include one or more VNFs (e.g., a router or bridge VNF, a network address translation (NAT) function VNF, an accelerator or compressor VNF, a firewall VNF, etc.). The first client 201, the second client 203, NC nodes and NEC nodes may be linked to each other by a transport (e.g., coax cable, fiber optic cable, etc.). The first client 201 may store content in a node (e.g., a content delivery VNF 207), which may be accessed by the second client 203. Accordingly, the network may provide a path to store or access content to the second client 203 utilizing a plurality of VNFs operating on NC or NEC nodes.

Multiple VNF types (router or bridge VNF, NAT function VNF, accelerator or compressor VNF, firewall VNF, etc.) may reside on a single NC node or NEC node. In this instance, transport cost, capacity, feature/functionality, etc., related to operating multiple VNF types on the NC nodes or NEC nodes are not considered because any VNFs needed by the NC node or NEC node would reside on the NC node or NEC node. Because multiple VNF types reside on NC nodes or NEC nodes, content delivery, firewall operations, or NAT functions may be placed closest to the second client 203, for example, NEC 221.

FIG. 2B is a block network 250 illustrating connecting two or more clients via a communication network in which multiple VNFs reside on one or more nodes according examples of the present disclosure. A first client 251 may connect to a second client 253 via a network (e.g., network 100) having a plurality of nodes (e.g., Network Cloud (NC) nodes or Network Edge Cloud (NEC) nodes). NECs (e.g., NEC node 255, NEC node 259, NEC node 263, and NEC node 271) and NCs (e.g., NC node 257, NC node 265, NC node 261, NC node 267, and NC node 269) may each include a VNF (e.g., a router or bridge VNF, a network address translation (NAT) function VNF, an accelerator or compressor VNF, a firewall VNF, etc.). The first client 251, the second client 253, NC nodes and NEC nodes may be linked to each other by a transport (e.g., wired or wireless). The first client 251 may store content in a node (e.g., a content delivery VNF 257), which may be accessed by the second client 253. Accordingly, the network may provide a path to the second client 203 to store or access content utilizing a plurality of VNFs operating on NC or NEC nodes.

Here, multiple VNF types may not reside on a single NC node or NEC node because certain VNFs may not be able to operate with other VNFs on the same NC node or NEC node due to (e.g., capacity, functionality, etc.). Accordingly, transport cost, operational cost for hosting a VNF, capacity, feature/functionality, etc., related to operating multiple VNF types on the NC nodes or NEC nodes are considered.

In this instance, the SDN Controller 105 may determine a path from the first client 251 to the second client 253 through the network in consideration on a number of nodes that may provide possible paths between the first client 251 and the second client 253. The SDN Controller 105 may optimize the network by incorporating a scout into each NC or NEC node. The scout may be a lightweight program (e.g., a container or virtual machine (VM)) used to assess placement of a particular VNF having a particular VNF type in a specific location (e.g., a specific NC node or NEC node in the network). The scout may be assigned a designated scout type (e.g., router or bridge VNF scout, NAT function VNF scout, accelerator VNF scout, compressor VNF scout, firewall VNF scout, etc.). The scout may simulate operation of a VNF on the specific NC node or NEC node according to the assigned scout type. Accordingly, the SDN Controller 105 may consider operation of the VNF of a particular VNF type on a particular NC node or NEC node. For example, the scout can receive routing information from other VNFs (e.g., router VNF 255, router VNF 255, router VNF 259, or router VNF 263) which may be residing on other NC or NEC nodes without switching traffic. Upon receiving routing information, the SDN Controller 105 may assess network traffic and determine an effect of moving a VNF to one NC node or NEC node to another NC node or NEC node in the network in consideration of a scout type for each scout in an NC node or NEC node. Accordingly, the SDN Controller 105 may determine an optimal VNF placement for each VNF along a path from the first client 251 and the second client 253 prior to actually moving the VNF to another NC node or NEC node. In addition, scouts may communicate with each other to form an optimized solution to relocate VNFs among themselves, and then trigger OSS functions to implement the solution thereby producing a real-time (or near-real-time) continuous optimization of the network in an automated manner.

Accordingly, the SDN Controller 105 may utilize scouts to assess an impact of a VNF placement at a certain location in a path and to report on available NC node or NEC node resources. Each scout may include a scout type. The SDN Controller 105 may include intelligence to assess the placement of a VNF at a particular location (e.g., a cloud node). The scouts may utilize minimal compute resources. The scout is a light version of a VNF. A VNF (e.g., a router software running on a virtual machine) conventionally consumes a lot of resources in a cloud node (e.g. a server that hosts VMs). The carrier has chosen not to install that VNF on that particular cloud node most likely for cost/capacity reasons. In this scenario, there are scouts for the several different VNFs installed on the cloud nodes. So, the scout may be a lightweight process as to not burden the network, listening to advertisements, etc. and effectively deciding whether it should install the actual VNF.

Scouts for all or some VNF types may be deployed on all cloud nodes and each scout may evaluate the possibility of a particular VNF being deployed on a particular node. The SDN Controller 105 may establish a communication infrastructure that allows the scouts, VNFs, and NC nodes and NEC nodes to communicate. The SDN Controller 105 may provide a messaging infrastructure between NC nodes, NEC nodes, VNFs and scouts. The SDN Controller 105 may also provide a standard means to quantify benefits so various solutions can be objectively compared. Installing a VNF on a node (e.g. put a contentNode close to the majority of its users) is beneficial since it may save network transport costs. But the possible installation may also come with licensing cost and CPU/memory cost on that particular cloud node. So, in this case, when the contentNode is being advertised as a “prospectiveFeature” along with it, information is sent about the cost of installing that node should that be required. These “costs” (e.g., referred herein as metrics) then can be weight against savings in lighter traffic through the network to decide whether the VNF should be installed on the particular node.

The SDN Controller 105 may utilize a distributed algorithm that scales with the number of nodes in the network. When analyzing each node, the SDN Controller 105 may consider neighboring nodes of the analyzed node thereby accommodating a network complexity of O(n) instead of O(n2). Results of the analysis (e.g., NC node or NEC node, node location, VNFs residing on the NC node or NEC node, scout, scout type, etc.) may be stored in, for example, a functional table. The SDN Controller 105 may also provide a mechanism to move a VNF from a location (e.g., a particular NC node or NEC node) to another location (e.g., a particular NC node or NEC node) in consideration of licensing, service impacts, SLAs etc., in a manner that does not interrupt a service.

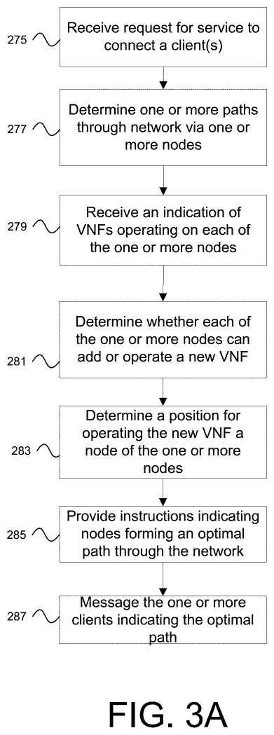

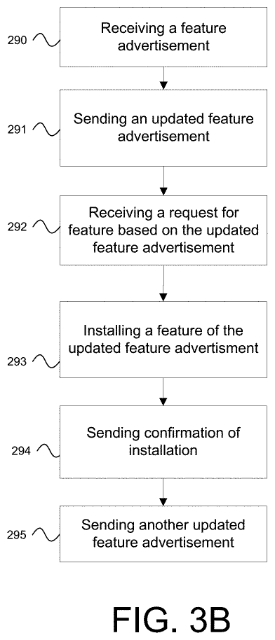

An exemplary operational flowchart in accordance with a method of the present disclosure is illustrated in FIG. 3A. At block 275, a network resource (e.g., a SDN controller) may receive a request to connect one or more clients to perform a service using a path through a network. At block 277, the network resource may determine one or more paths connecting the one or more clients via a plurality of nodes (e.g., an NC node or NEC node) within the network. At block 279, the network resource may receive an indication of VNFs operating on each of the plurality of nodes.

At block 281, the network resource may determine whether one or more nodes associated with a given path of the one or more paths can add and operate a new VNF on a particular node in light of the indication of VNFs already operating on that node. The determination may be in consideration of VNF types assigned to the new VNF and VNFs already operating on that node.

At block 283, the network resource may determine a position for operating the new VNF within a node in a given path of the one or more paths. The determination may also be based on a variety of parameters (e.g., transport costs, delay costs, capacity, reliability, transport utilization, whether a VNF can operate with other VNF(s) on a particular cloud node, capacity, feature/functionality, etc.) and thresholds on those parameters. The determination may also be made utilizing one or more scouts stored on the particular node that are capable of simulating operation of the new VNF before moving the VNF to the particular node. The determination may result in an indication of an optimal path connecting the one or more clients, which indicates nodes where particular VNFs are to be located. At block 285, the network resource may provide instructions to the one or more clients indicating nodes forming the optimal path to conduct the requested service, which node in the optimal path stores the new VNF, as well as operation of the new VNF on the node.

FIG. 3B illustrates another exemplary method flow in context of another scenario. At step 290, receiving by NC node 257, an advertisement that includes the different features of a plurality of nodes in a network, which may include VNFs installed or the VNFs capable of being installed. Note each node of a plurality of nodes of network 250 (e.g., NEC node 255, NEC node 259, NEC node 263, NEC node 271, NC node 257, NC node 265, NC node 261, NC node 267, or NC node 269) may have different VNFs (e.g., capabilities) installed. It is contemplated that VNFs may be installed and removed over a period based on different factors, such as how frequent the VNF is used, memory capacity, memory availability, node outages, or the like.

At step 291, sending and advertisement of the features of NC node 257 to the network. NC node 257 may advertise via broadcast or multicast. The sent advertisement by NC node 257 may also include the received advertisement of step 290. These advertisements flow through the network with each node adding the features it has. Note that each node receives requests from many other nodes, so what it advertises may be the aggregate of the advertisements nodes it receives. In an example scenario, NC node 257 may advertise that it has a routing feature installed and has the capability to install a LAN compression feature. The advertisement could look like the following “destination=INTERNET, features=ROUTER, FIREWALL, prospectiveFeatures=LANCOMPRESSION).

At step 292, receiving by NC node 257, a request for LAN compression to be installed. At step 293, in response to the request of step 292, installing the LAN compression feature. It is contemplated that NC node 257 may need to uninstall certain features to complete the request of step 292. This may be a factor into whether a feature is installed. At step 294, sending a message confirming the installation of step 293. At step 295, sending an updated advertisement of the features of NC node 257. It is contemplated herein that the disclosed subject matter may be used to create an optimal path between source and destination with one or more requested features. There may be different features requested and implemented on each node along the path. The steps of the methods herein may occur on one device or a plurality of devices.

Accordingly, the present disclosure provides a system that optimizes VNFs running on cloud nodes of a software defined network, such as network cloud nodes, in a distributed and scalable manner that can account for network expansion. The system described herein may reduce lead times for network reconfiguration and optimization, allow a network to rapidly reconfigure itself in order to meet dynamic and shifting demands associated with new technologies, such as 5G, IoT, streaming, virtual reality, etc., and saves underutilized resources in order to reduce network costs.

The system described herein may utilize an algorithm that determines an optimal path connecting one or more clients. The algorithm may assume a communication network with a goal of providing access to a set of destinations (e.g., client sites, a content server somewhere in the network, data center, or other similar destination). The algorithm may also assume that cloud nodes have sufficient capacity to house VNFs that are produced by the solution and that transmission facilities have sufficient bandwidth among the cloud nodes to allow VNF-VNF traffic among the cloud nodes.

The algorithm determines a set of features used to access the destination, which may be network services that should be met to access the destination. For example, a certain destination may utilize a firewall or a certain delay characteristic. The algorithm may also utilize a quantization factor to access cost and revenue associated with each destination in order to produce a value number for the service (e.g., revenue, costs. profit, etc.), which the algorithm attempts to maximize. The revenue and cost factors may be fixed costs (e.g., cost of VNFs needed) or variable costs (e.g., cost per Mbps, or discount for each millisecond of delay, etc.)

The algorithm may be triggered by a request to calculate the best configuration to a set of “destinations” with a set of “features.” The algorithm utilizes information from scouts that are closest to the destination. A scout associated with a particular cloud node may act as a channel to the other cloud nodes and collect advertisements from each scout, as well as relay an aggregate of advertisements to adjacent cloud node scouts. Each adjacent cloud node scout receiving the aggregate of advertisements may add a cost/value impact of transmission between the adjacent cloud node and a transmitter node, which may be presented to all the scouts on a cloud node.

A self-assembly process described in the algorithm may be based on the advertisements of local scouts of a cloud node, as well as remote scouts from the adjacent nodes. New advertisements are collected from local scouts and added to a list of advertisements received from another node and are broadcast to neighboring nodes. Advertisements may flow through the network using a set of self-assembled scouts indicating an optimum placement of VNFs within network cloud nodes. The self-assembly process may end when reconfigurations stop (e.g., there is no more optimum upstream connection for any scout).

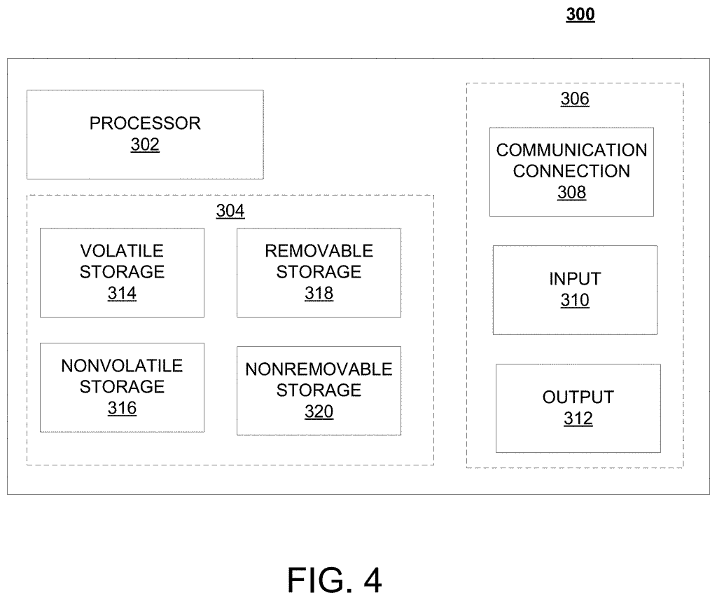

FIG. 4 is a block diagram of network device 300 that may be connected to or comprise a component of edge computing node or connected to edge computing node via a network. Network device 300 may comprise hardware or a combination of hardware and software. The functionality to facilitate telecommunications via a telecommunications network may reside in one or combination of network devices 300. Network device 300 depicted in FIG. 4 may represent or perform functionality of an appropriate network device 300, or combination of network devices 300, such as, for example, a component or various components of a cellular broadcast system wireless network, a processor, a server, a gateway, a node, a mobile switching center (MSC), a short message service center (SMSC), an ALFS, a gateway mobile location center (GMLC), a radio access network (RAN), a serving mobile location center (SMLC), or the like, or any appropriate combination thereof. It is emphasized that the block diagram depicted in FIG. 4 is exemplary and not intended to imply a limitation to a specific implementation or configuration. Thus, network device 300 may be implemented in a single device or multiple devices (e.g., single server or multiple servers, single gateway or multiple gateways, single controller, or multiple controllers). Multiple network entities may be distributed or centrally located. Multiple network entities may communicate wirelessly, via hard wire, or any appropriate combination thereof.

Network device 300 may comprise a processor 302 and a memory 304 coupled to processor 302. Memory 304 may contain executable instructions that, when executed by processor 302, cause processor 302 to effectuate operations associated with mapping wireless signal strength.

In addition to processor 302 and memory 304, network device 300 may include an input/output system 306. Processor 302, memory 304, and input/output system 306 may be coupled together (coupling not shown in FIG. 4) to allow communications therebetween. Each portion of network device 300 may comprise circuitry for performing functions associated with each respective portion. Thus, each portion may comprise hardware, or a combination of hardware and software. Input/output system 306 may be capable of receiving or providing information from or to a communications device or other network entities configured for telecommunications. For example, input/output system 306 may include a wireless communications (e.g., 3G/4G/GPS) card. Input/output system 306 may be capable of receiving or sending video information, audio information, control information, image information, data, or any combination thereof. Input/output system 306 may be capable of transferring information with network device 300. In various configurations, input/output system 306 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 306 may comprise a Wi-Fi finder, a two-way GPS chipset or equivalent, or the like, or a combination thereof.

Input/output system 306 of network device 300 also may contain a communication connection 308 that allows network device 300 to communicate with other devices, network entities, or the like. Communication connection 308 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 306 also may include an input device 310 such as keyboard, mouse, pen, voice input device, or touch input device. Input/output system 306 may also include an output device 312, such as a display, speakers, or a printer.

Processor 302 may be capable of performing functions associated with telecommunications, such as functions for processing broadcast messages, as described herein. For example, processor 302 may be capable of, in conjunction with any other portion of network device 300, determining a type of broadcast message and acting according to the broadcast message type or content, as described herein.

Memory 304 of network device 300 may comprise a storage medium having a concrete, tangible, physical structure. As is known, a signal does not have a concrete, tangible, physical structure. Memory 304, as well as any computer-readable storage medium described herein, is not to be construed as a signal. Memory 304, as well as any computer-readable storage medium described herein, is not to be construed as a transient signal. Memory 304, as well as any computer-readable storage medium described herein, is not to be construed as a propagating signal. Memory 304, as well as any computer-readable storage medium described herein, is to be construed as an article of manufacture.

Memory 304 may store any information utilized in conjunction with telecommunications. Depending upon the exact configuration or type of processor, memory 304 may include a volatile storage 314 (such as some types of RAM), a nonvolatile storage 316 (such as ROM, flash memory), or a combination thereof. Memory 304 may include additional storage (e.g., a removable storage 318 or a nonremovable storage 320) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by network device 300. Memory 304 may comprise executable instructions that, when executed by processor 302, cause processor 302 to effectuate operations to map signal strengths in an area of interest.

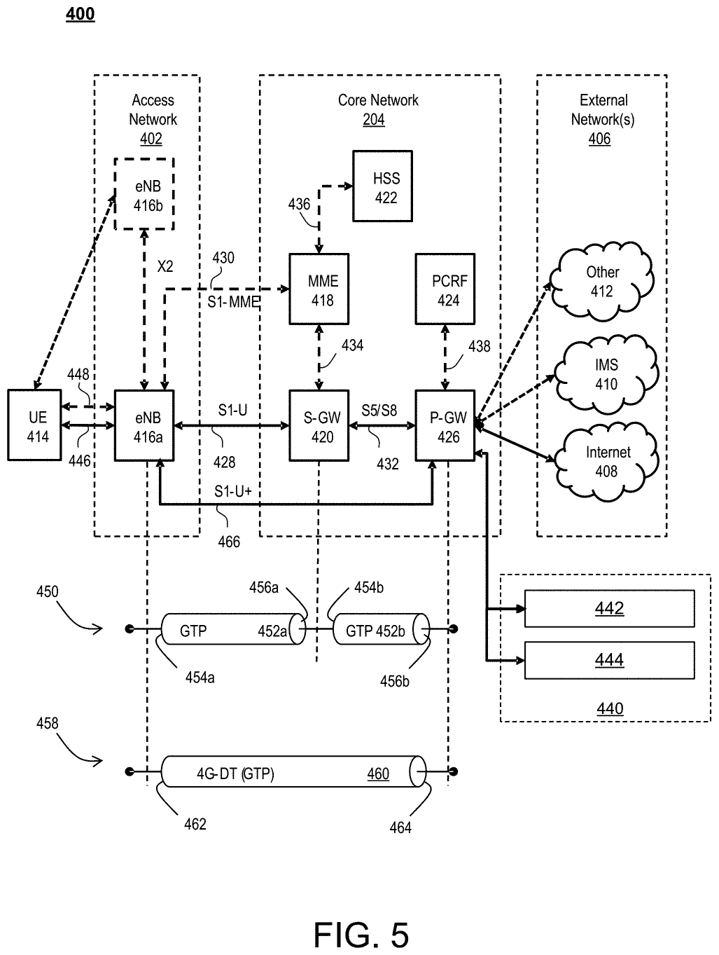

FIG. 5 illustrates a functional block diagram depicting one example of an LTE-EPS network architecture 400 related to the current disclosure. In particular, the network architecture 400 disclosed herein is referred to as a modified LTE-EPS architecture 400 to distinguish it from a traditional LTE-EPS architecture.

An example modified LTE-EPS architecture 400 is based at least in part on standards developed by the 3rd Generation Partnership Project (3GPP), with information available at www.3gpp.org. In one embodiment, the LTE-EPS network architecture 400 includes an access network 402, a core network 404, e.g., an EPC or Common BackBone (CBB) and one or more external networks 406, sometimes referred to as PDN or peer entities. Different external networks 406 can be distinguished from each other by a respective network identifier, e.g., a label according to DNS naming conventions describing an access point to the PDN. Such labels can be referred to as Access Point Names (APN). External networks 406 can include one or more trusted and non-trusted external networks such as an internet protocol (IP) network 408, an IP multimedia subsystem (IMS) network 410, and other networks 412, such as a service network, a corporate network, or the like.

Access network 402 can include an LTE network architecture sometimes referred to as Evolved Universal mobile Telecommunication system Terrestrial Radio Access (E UTRA) and evolved UMTS Terrestrial Radio Access Network (E-UTRAN). Broadly, access network 402 can include one or more communication devices, commonly referred to as UE 414, and one or more wireless access nodes, or base stations 416a, 416b. During network operations, at least one base station 416 communicates directly with UE 414. Base station 416 can be an evolved Node B (eNodeB), with which UE 414 communicates over the air and wirelessly. UEs 414 can include, without limitation, wireless devices, e.g., satellite communication systems, portable digital assistants (PDAs), laptop computers, tablet devices, Internet-of-things (IoT) devices, and other mobile devices (e.g., cellular telephones, smart appliances, and so on). UEs 414 can connect to eNBs 416 when UE 414 is within range according to a corresponding wireless communication technology.

UE 414 generally runs one or more applications that engage in a transfer of packets between UE 414 and one or more external networks 406. Such packet transfers can include one of downlink packet transfers from external network 406 to UE 414, uplink packet transfers from UE 414 to external network 406 or combinations of uplink and downlink packet transfers. Applications can include, without limitation, web browsing, VoIP, streaming media, and the like. Each application can pose different Quality of Service (QoS) requirements on a respective packet transfer. Different packet transfers can be served by different bearers within core network 404, e.g., according to parameters, such as the QoS.

Core network 404 uses a concept of bearers, e.g., EPS bearers, to route packets, e.g., IP traffic, between a particular gateway in core network 404 and UE 414. A bearer refers generally to an IP packet flow with a defined QoS between the particular gateway and UE 414. Access network 402, e.g., E UTRAN, and core network 404 together set up and release bearers as required by the various applications. Bearers can be classified in at least two different categories: (i) minimum guaranteed bit rate bearers, e.g., for applications, such as VoIP; and (ii) non-guaranteed bit rate bearers that do not require guarantee bit rate, e.g., for applications, such as web browsing.

In one embodiment, the core network 404 includes various network entities, such as MME 418, SGW 420, Home Subscriber Server (HSS) 422, Policy and Charging Rules Function (PCRF) 424 and PGW 426. In one embodiment, MME 418 comprises a control node performing a control signaling between various equipment and devices in access network 402 and core network 404. The protocols running between UE 414 and core network 404 are generally known as Non-Access Stratum (NAS) protocols.

For illustration purposes only, the terms MME 418, SGW 420, HSS 422 and PGW 426, and so on, can be server devices, but may be referred to in the subject disclosure without the word “server.” It is also understood that any form of such servers can operate in a device, system, component, or other form of centralized or distributed hardware and software. It is further noted that these terms and other terms such as bearer paths or interfaces are terms that can include features, methodologies, or fields that may be described in whole or in part by standards bodies such as the 3GPP. It is further noted that some or all embodiments of the subject disclosure may in whole or in part modify, supplement, or otherwise supersede final or proposed standards published and promulgated by 3GPP.

According to traditional implementations of LTE-EPS architectures, SGW 420 routes and forwards all user data packets. SGW 420 also acts as a mobility anchor for user plane operation during handovers between base stations, e.g., during a handover from first eNB 416a to second eNB 416b as may be the result of UE 414 moving from one area of coverage, e.g., cell, to another. SGW 420 can also terminate a downlink data path, e.g., from external network 406 to UE 414 in an idle state and trigger a paging operation when downlink data arrives for UE 414. SGW 420 can also be configured to manage and store a context for UE 414, e.g., including one or more of parameters of the IP bearer service and network internal routing information. In addition, SGW 420 can perform administrative functions, e.g., in a visited network, such as collecting information for charging (e.g., the volume of data sent to or received from the user), or replicate user traffic, e.g., to support a lawful interception. SGW 420 also serves as the mobility anchor for interworking with other 3GPP technologies such as universal mobile telecommunication system (UMTS).

At any given time, UE 414 is generally in one of three different states: detached, idle, or active. The detached state is typically a transitory state in which UE 414 is powered on but is engaged in a process of searching and registering with network 402. In the active state, UE 414 is registered with access network 402 and has established a wireless connection, e.g., radio resource control (RRC) connection, with eNB 416. Whether UE 414 is in an active state can depend on the state of a packet data session, and whether there is an active packet data session. In the idle state, UE 414 is generally in a power conservation state in which UE 414 typically does not communicate packets. When UE 414 is idle, SGW 420 can terminate a downlink data path, e.g., from one peer entity 406, and triggers paging of UE 414 when data arrives for UE 414. If UE 414 responds to the page, SGW 420 can forward the IP packet to eNB 416a.

HSS 422 can manage subscription-related information for a user of UE 414. For example, HSS 422 can store information such as authorization of the user, security requirements for the user, quality of service (QoS) requirements for the user, etc. HSS 422 can also hold information about external networks 406 to which the user can connect, e.g., in the form of an APN of external networks 406. For example, MME 418 can communicate with HSS 422 to determine if UE 414 is authorized to establish a call, e.g., a voice over IP (VoIP) call before the call is established.

PCRF 424 can perform QoS management functions and policy control. PCRF 424 is responsible for policy control decision-making, as well as for controlling the flow-based charging functionalities in a policy control enforcement function (PCEF), which resides in PGW 426. PCRF 424 provides the QoS authorization, e.g., QoS class identifier and bit rates that decide how a certain data flow will be treated in the PCEF and ensures that this is in accordance with the user's subscription profile.

PGW 426 can provide connectivity between the UE 414 and one or more of the external networks 406. In illustrative network architecture 400, PGW 426 can be responsible for IP address allocation for UE 414, as well as one or more of QoS enforcement and flow-based charging, e.g., according to rules from the PCRF 424. PGW 426 is also typically responsible for filtering downlink user IP packets into the different QoS-based bearers. In at least some embodiments, such filtering can be performed based on traffic flow templates. PGW 426 can also perform QoS enforcement, e.g., for guaranteed bit rate bearers. PGW 426 also serves as a mobility anchor for interworking with non-3GPP technologies such as CDMA2000.

Within access network 402 and core network 404 there may be various bearer paths/interfaces, e.g., represented by solid lines 428 and 430. Some of the bearer paths can be referred to by a specific label. For example, solid line 428 can be considered an S1-U bearer and solid line 432 can be considered an S5/S8 bearer according to LTE-EPS architecture standards. Without limitation, reference to various interfaces, such as S1, X2, S5, S8, S11 refer to EPS interfaces. In some instances, such interface designations are combined with a suffix, e.g., a “U” or a “C” to signify whether the interface relates to a “User plane” or a “Control plane.” In addition, the core network 404 can include various signaling bearer paths/interfaces, e.g., control plane paths/interfaces represented by dashed lines 430, 434, 436, and 438. Some of the signaling bearer paths may be referred to by a specific label. For example, dashed line 430 can be considered as an S1-MME signaling bearer, dashed line 434 can be considered as an S11 signaling bearer and dashed line 436 can be considered as an Sha signaling bearer, e.g., according to LTE-EPS architecture standards. The above bearer paths and signaling bearer paths are only illustrated as examples and it should be noted that additional bearer paths and signaling bearer paths may exist that are not illustrated.

Also shown is a novel user plane path/interface, referred to as the S1-U+ interface 466. In the illustrative example, the S1-U+ user plane interface extends between the eNB 416a and PGW 426. Notably, S1-U+ path/interface does not include SGW 420, a node that is otherwise instrumental in configuring or managing packet forwarding between eNB 416a and one or more external networks 406 by way of PGW 426. As disclosed herein, the S1-U+ path/interface facilitates autonomous learning of peer transport layer addresses by one or more of the network nodes to facilitate a self-configuring of the packet forwarding path. In particular, such self-configuring can be accomplished during handovers in most scenarios so as to reduce any extra signaling load on the S/PGWs 420, 426 due to excessive handover events.

In some embodiments, PGW 426 is coupled to storage device 440, shown in phantom. Storage device 440 can be integral to one of the network nodes, such as PGW 426, for example, in the form of internal memory or disk drive. It is understood that storage device 440 can include registers suitable for storing address values. Alternatively, or in addition, storage device 440 can be separate from PGW 426, for example, as an external hard drive, a flash drive, or network storage.

Storage device 440 selectively stores one or more values relevant to the forwarding of packet data. For example, storage device 440 can store identities or addresses of network entities, such as any of network nodes 418, 420, 422, 424, and 426, eNBs 416 or UE 414. In the illustrative example, storage device 440 includes a first storage location 442 and a second storage location 444. First storage location 442 can be dedicated to storing a Currently Used Downlink address value 442. Likewise, second storage location 444 can be dedicated to storing a Default Downlink Forwarding address value 444. PGW 426 can read or write values into either of storage locations 442, 444, for example, managing Currently Used Downlink Forwarding address value 442 and Default Downlink Forwarding address value 444 as disclosed herein.

In some embodiments, the Default Downlink Forwarding address for each EPS bearer is the SGW S5-U address for each EPS Bearer. The Currently Used Downlink Forwarding address” for each EPS bearer in PGW 426 can be set every time when PGW 426 receives an uplink packet, e.g., a GTP-U uplink packet, with a new source address for a corresponding EPS bearer. When UE 414 is in an idle state, the “Current Used Downlink Forwarding address” field for each EPS bearer of UE 414 can be set to a “null” or other suitable value.

In some embodiments, the Default Downlink Forwarding address is only updated when PGW 426 receives a new SGW S5-U address in a predetermined message or messages. For example, the Default Downlink Forwarding address is only updated when PGW 426 receives one of a Create Session Request, Modify Bearer Request and Create Bearer Response messages from SGW 420.

As values 442, 444 can be maintained and otherwise manipulated on a per bearer basis, it is understood that the storage locations can take the form of tables, spreadsheets, lists, or other data structures generally well understood and suitable for maintaining or otherwise manipulate forwarding addresses on a per bearer basis.

It should be noted that access network 402 and core network 404 are illustrated in a simplified block diagram in FIG. 5. In other words, either or both of access network 402 and the core network 404 can include additional network elements that are not shown, such as various routers, switches, and controllers. In addition, although FIG. 5 illustrates only a single one of each of the various network elements, it should be noted that access network 402 and core network 404 can include any number of the various network elements. For example, core network 404 can include a pool (i.e., more than one) of MMEs 418, SGWs 420 or PGWs 426.

In the illustrative example, data traversing a network path between UE 414, eNB 416a, SGW 420, PGW 426 and external network 406 may be considered to constitute data transferred according to an end-to-end IP service. However, for the present disclosure, to properly perform establishment management in LTE-EPS network architecture 400, the core network, data bearer portion of the end-to-end IP service is analyzed.

An establishment may be defined herein as a connection set up request between any two elements within LTE-EPS network architecture 400. The connection set up request may be for user data or for signaling. A failed establishment may be defined as a connection set up request that was unsuccessful. A successful establishment may be defined as a connection set up request that was successful.

In one embodiment, a data bearer portion comprises a first portion (e.g., a data radio bearer 446) between UE 414 and eNB 416a, a second portion (e.g., an S1 data bearer 428) between eNB 416a and SGW 420, and a third portion (e.g., an S5/S8 bearer 432) between SGW 420 and PGW 426. Various signaling bearer portions are also illustrated in FIG. 5. For example, a first signaling portion (e.g., a signaling radio bearer 448) between UE 414 and eNB 416a, and a second signaling portion (e.g., S1 signaling bearer 430) between eNB 416a and MME 418.

In at least some embodiments, the data bearer can include tunneling, e.g., IP tunneling, by which data packets can be forwarded in an encapsulated manner, between tunnel endpoints. Tunnels, or tunnel connections can be identified in one or more nodes of network 400, e.g., by one or more of tunnel endpoint identifiers, an IP address, and a user datagram protocol port number. Within a particular tunnel connection, payloads, e.g., packet data, which may or may not include protocol related information, are forwarded between tunnel endpoints.

An example of first tunnel solution 450 includes a first tunnel 452a between two tunnel endpoints 454a and 456a, and a second tunnel 452b between two tunnel endpoints 454b and 456b. In the illustrative example, first tunnel 452a is established between eNB 416a and SGW 420. Accordingly, first tunnel 452a includes a first tunnel endpoint 454a corresponding to an S1-U address of eNB 416a (referred to herein as the eNB S1-U address), and second tunnel endpoint 456a corresponding to an S1-U address of SGW 420 (referred to herein as the SGW S1-U address). Likewise, second tunnel 452b includes first tunnel endpoint 454b corresponding to an S5-U address of SGW 420 (referred to herein as the SGW S5-U address), and second tunnel endpoint 456b corresponding to an S5-U address of PGW 426 (referred to herein as the PGW S5-U address).

In at least some embodiments, first tunnel solution 450 is referred to as a two-tunnel solution, e.g., according to the GPRS Tunneling Protocol User Plane (GTPv1-U based), as described in 3GPP specification TS 29.281, incorporated herein in its entirety. It is understood that one or more tunnels are permitted between each set of tunnel end points. For example, each subscriber can have one or more tunnels, e.g., one for each PDP context that they have active, as well as possibly having separate tunnels for specific connections with different quality of service requirements, and so on.

An example of second tunnel solution 458 includes a single or direct tunnel 460 between tunnel endpoints 462 and 464. In the illustrative example, direct tunnel 460 is established between eNB 416a and PGW 426, without subjecting packet transfers to processing related to SGW 420. Accordingly, direct tunnel 460 includes first tunnel endpoint 462 corresponding to the eNB S1-U address, and second tunnel endpoint 464 corresponding to the PGW S5-U address. Packet data received at either end can be encapsulated into a payload and directed to the corresponding address of the other end of the tunnel. Such direct tunneling avoids processing, e.g., by SGW 420 that would otherwise relay packets between the same two endpoints, e.g., according to a protocol, such as the GTP-U protocol.

In some scenarios, direct tunneling solution 458 can forward user plane data packets between eNB 416a and PGW 426, by way of SGW 420. For example, SGW 420 can serve a relay function, by relaying packets between two tunnel endpoints 416a, 426. In other scenarios, direct tunneling solution 458 can forward user data packets between eNB 416a and PGW 426, by way of the S1 U+ interface, thereby bypassing SGW 420.

Generally, UE 414 can have one or more bearers at any one time. The number and types of bearers can depend on applications, default requirements, and so on. It is understood that the techniques disclosed herein, including the configuration, management and use of various tunnel solutions 450, 458, can be applied to the bearers on an individual basis. For example, if user data packets of one bearer, say a bearer associated with a VoIP service of UE 414, then the forwarding of all packets of that bearer are handled in a similar manner. Continuing with this example, the same UE 414 can have another bearer associated with it through the same eNB 416a. This other bearer, for example, can be associated with a relatively low rate data session forwarding user data packets through core network 404 simultaneously with the first bearer. Likewise, the user data packets of the other bearer are also handled in a similar manner, without necessarily following a forwarding path or solution of the first bearer. Thus, one of the bearers may be forwarded through direct tunnel 458; whereas, another one of the bearers may be forwarded through a two-tunnel solution 450.

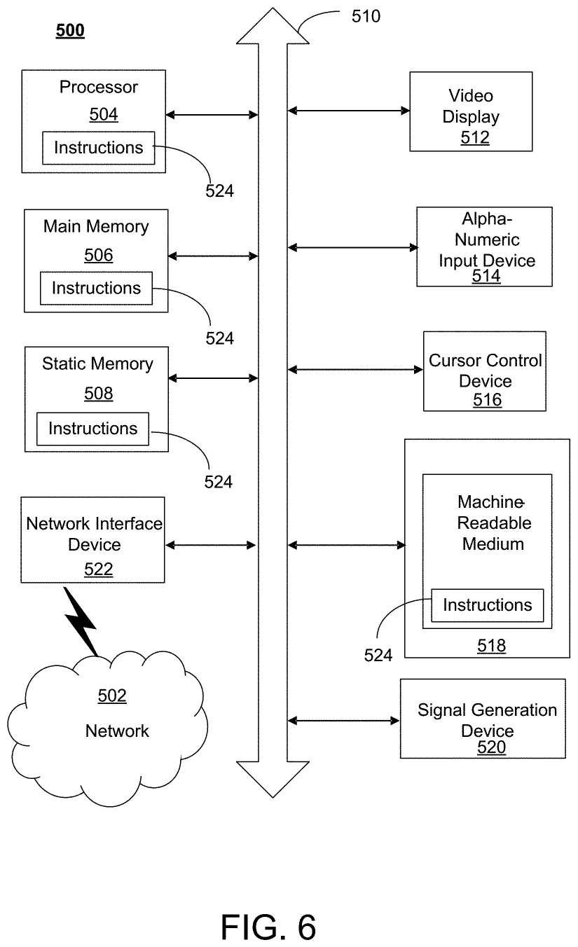

FIG. 6 depicts an exemplary diagrammatic representation of a machine in the form of a computer system 500 within which a set of instructions, when executed, may cause the machine to perform any one or more of the methods described above. One or more instances of the machine can operate, for example, as processor 302, UE 414, eNB 416, MME 418, SGW 420, HSS 422, PCRF 424, PGW 426 and other devices of FIGS. 1, 2, and 4. In some embodiments, the machine may be connected (e.g., using a network 502) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video, or data communication. Further, while a single machine is illustrated, the term “machine” shall also be taken to include any collection of machines that individually or jointly execute a set (or multiple sets) of instructions to perform any one or more of the methods discussed herein.

Computer system 500 may include a processor (or controller) 504 (e.g., a central processing unit (CPU)), a graphics processing unit (GPU, or both), a main memory 506 and a static memory 508, which communicate with each other via a bus 510. The computer system 500 may further include a display unit 512 (e.g., a liquid crystal display (LCD), a flat panel, or a solid-state display). Computer system 500 may include an input device 514 (e.g., a keyboard), a cursor control device 516 (e.g., a mouse), a disk drive unit 518, a signal generation device 520 (e.g., a speaker or remote control) and a network interface device 522. In distributed environments, the embodiments described in the subject disclosure can be adapted to utilize multiple display units 512 controlled by two or more computer systems 500. In this configuration, presentations described by the subject disclosure may in part be shown in a first of display units 512, while the remaining portion is presented in a second of display units 512.

The disk drive unit 518 may include a tangible computer-readable storage medium 524 on which is stored one or more sets of instructions (e.g., software 526) embodying any one or more of the methods or functions described herein, including those methods illustrated above. Instructions 526 may also reside, completely or at least partially, within main memory 506, static memory 508, or within processor 504 during execution thereof by the computer system 500. Main memory 506 and processor 504 also may constitute tangible computer-readable storage media.

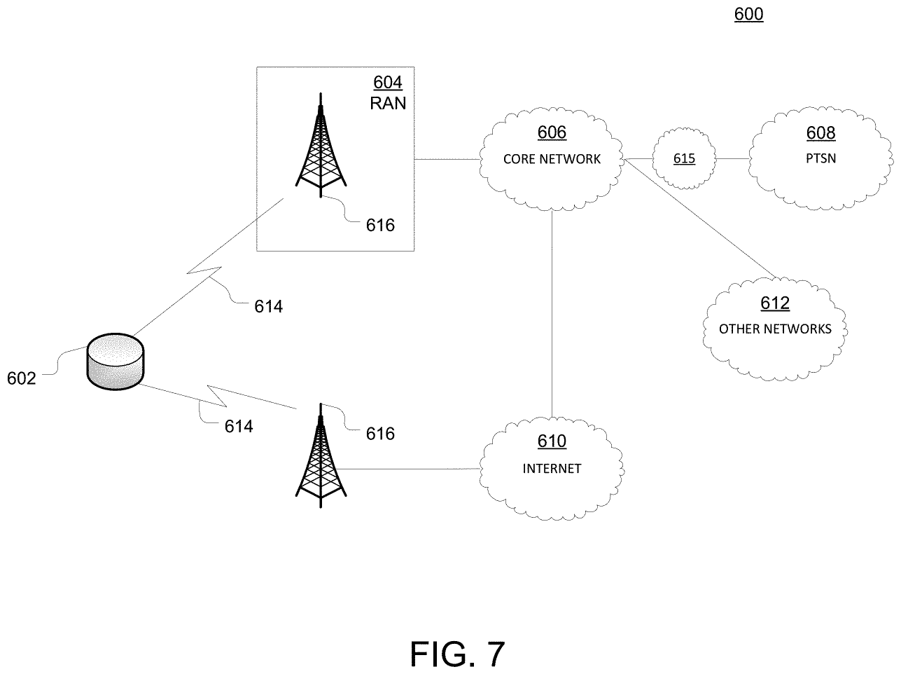

As shown in FIG. 7, telecommunication system 600 may include wireless transmit/receive units (WTRUs) 602, a RAN 604, a core network 606, a public switched telephone network (PSTN) 608, the Internet 610, or other networks 612, though it will be appreciated that the disclosed examples contemplate any number of WTRUs, base stations, networks, or network elements. Each WTRU 602 may be any type of device configured to operate or communicate in a wireless environment. For example, a WTRU may comprise IoT devices 32, mobile devices 33, network device 300, or the like, or any combination thereof. By way of example, WTRUs 602 may be configured to transmit or receive wireless signals and may include a UE, a mobile station, a mobile device, a fixed or mobile subscriber unit, a pager, a cellular telephone, a PDA, a smartphone, a laptop, a netbook, a personal computer, a wireless sensor, consumer electronics, or the like. WTRUs 602 may be configured to transmit or receive wireless signals over an air interface 614.

Telecommunication system 600 may also include one or more base stations 616. Each of base stations 616 may be any type of device configured to wirelessly interface with at least one of the WTRUs 602 to facilitate access to one or more communication networks, such as core network 606, PTSN 608, Internet 610, or other networks 612. By way of example, base stations 616 may be a base transceiver station (BTS), a Node-B, an eNodeB, a Home Node B, a Home eNodeB, a site controller, an access point (AP), a wireless router, or the like. While base stations 616 are each depicted as a single element, it will be appreciated that base stations 616 may include any number of interconnected base stations or network elements.

RAN 604 may include one or more base stations 616, along with other network elements (not shown), such as a base station controller (BSC), a radio network controller (RNC), or relay nodes. One or more base stations 616 may be configured to transmit or receive wireless signals within a particular geographic region, which may be referred to as a cell (not shown). The cell may further be divided into cell sectors. For example, the cell associated with base station 616 may be divided into three sectors such that base station 616 may include three transceivers: one for each sector of the cell. In another example, base station 616 may employ multiple-input multiple-output (MIMO) technology and, therefore, may utilize multiple transceivers for each sector of the cell.

Base stations 616 may communicate with one or more of WTRUs 602 over air interface 614, which may be any suitable wireless communication link (e.g., RF, microwave, infrared (IR), ultraviolet (UV), or visible light). Air interface 614 may be established using any suitable radio access technology (RAT).

More specifically, as noted above, telecommunication system 600 may be a multiple access system and may employ one or more channel access schemes, such as CDMA, TDMA, FDMA, OFDMA, SC-FDMA, or the like. For example, base station 616 in RAN 604 and WTRUs 602 connected to RAN 604 may implement a radio technology such as Universal Mobile Telecommunications System (UMTS) Terrestrial Radio Access (UTRA) that may establish air interface 614 using wideband CDMA (WCDMA). WCDMA may include communication protocols, such as High-Speed Packet Access (HSPA) or Evolved HSPA (HSPA+). HSPA may include High-Speed Downlink Packet Access (HSDPA) or High-Speed Uplink Packet Access (HSUPA).

As another example base station 616 and WTRUs 602 that are connected to RAN 604 may implement a radio technology such as Evolved UMTS Terrestrial Radio Access (E-UTRA), which may establish air interface 614 using LTE or LTE-Advanced (LTE-A).

Optionally base station 616 and WTRUs 602 connected to RAN 604 may implement radio technologies such as IEEE 602.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), GSM, Enhanced Data rates for GSM Evolution (EDGE), GSM EDGE (GERAN), or the like.

Base station 616 may be a wireless router, Home Node B, Home eNodeB, or access point, for example, and may utilize any suitable RAT for facilitating wireless connectivity in a localized area, such as a place of business, a home, a vehicle, a campus, or the like. For example, base station 616 and associated WTRUs 602 may implement a radio technology such as IEEE 602.11 to establish a wireless local area network (WLAN). As another example, base station 616 and associated WTRUs 602 may implement a radio technology such as IEEE 602.15 to establish a wireless personal area network (WPAN). In yet another example, base station 616 and associated WTRUs 602 may utilize a cellular-based RAT (e.g., WCDMA, CDMA2000, GSM, LTE, LTE-A, etc.) to establish a picocell or femtocell. As shown in FIG. 7, base station 616 may have a direct connection to Internet 610. Thus, base station 616 may not be required to access Internet 610 via core network 606.

RAN 604 may be in communication with core network 606, which may be any type of network configured to provide voice, data, applications, or voice over internet protocol (VoIP) services to one or more WTRUs 602. For example, core network 606 may provide call control, billing services, mobile location-based services, pre-paid calling, Internet connectivity, video distribution or high-level security functions, such as user authentication. Although not shown in FIG. 7, it will be appreciated that RAN 604 or core network 606 may be in direct or indirect communication with other RANs that employ the same RAT as RAN 604 or a different RAT. For example, in addition to being connected to RAN 604, which may be utilizing an E-UTRA radio technology, core network 606 may also be in communication with another RAN (not shown) employing a GSM radio technology.

Core network 606 may also serve as a gateway for WTRUs 602 to access PSTN 608, Internet 610, or other networks 612. PSTN 608 may include circuit-switched telephone networks that provide plain old telephone service (POTS). For LTE core networks, core network 606 may use IMS core 614 to provide access to PSTN 608. Internet 610 may include a global system of interconnected computer networks or devices that use common communication protocols, such as the transmission control protocol (TCP), user datagram protocol (UDP), or IP in the TCP/IP internet protocol suite. Other networks 612 may include wired or wireless communications networks owned or operated by other service providers. For example, other networks 612 may include another core network connected to one or more RANs, which may employ the same RAT as RAN 604 or a different RAT.

Some or all WTRUs 602 in telecommunication system 600 may include multi-mode capabilities. For example, WTRUs 602 may include multiple transceivers for communicating with different wireless networks over different wireless links. For example, one or more WTRUs 602 may be configured to communicate with base station 616, which may employ a cellular-based radio technology, and with base station 616, which may employ an IEEE 802 radio technology.

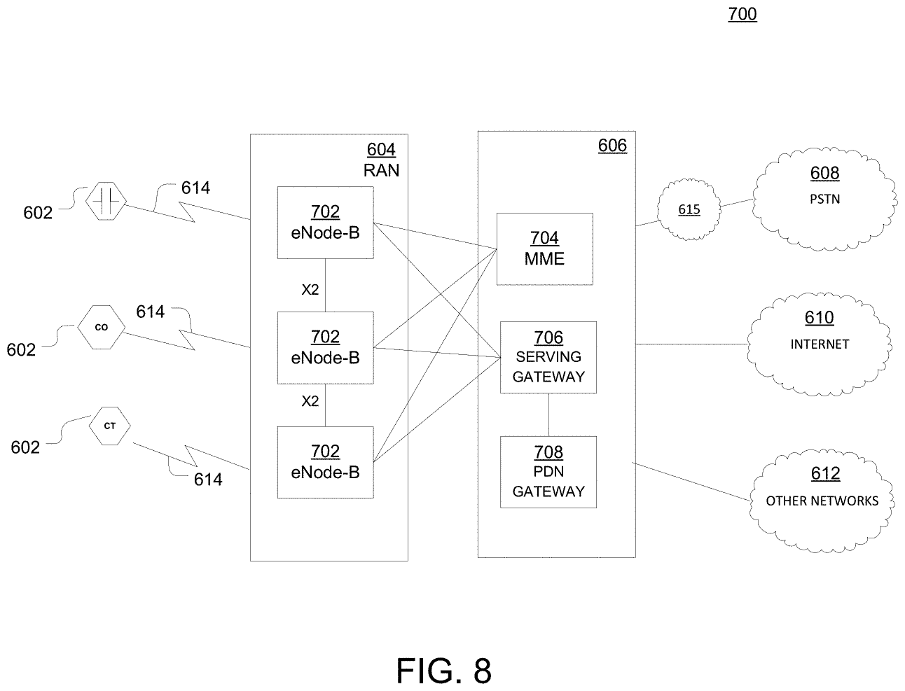

FIG. 8 is an example system 700 including RAN 604 and core network 606. As noted above, RAN 604 may employ an E-UTRA radio technology to communicate with WTRUs 602 over air interface 614. RAN 604 may also be in communication with core network 606.

RAN 604 may include any number of eNodeBs 702 while remaining consistent with the disclosed technology. One or more eNodeBs 702 may include one or more transceivers for communicating with the WTRUs 602 over air interface 614. Optionally, eNodeBs 702 may implement MIMO technology. Thus, one of eNodeBs 702, for example, may use multiple antennas to transmit wireless signals to, or receive wireless signals from, one of WTRUs 602.

Each of eNodeBs 702 may be associated with a particular cell (not shown) and may be configured to handle radio resource management decisions, handover decisions, scheduling of users in the uplink or downlink, or the like. As shown in FIG. 8 eNodeBs 702 may communicate with one another over an X2 interface.

Core network 606 shown in FIG. 8 may include a mobility management gateway or entity (MME) 704, a serving gateway 706, or a packet data network (PDN) gateway 708. While each of the foregoing elements are depicted as part of core network 606, it will be appreciated that any one of these elements may be owned or operated by an entity other than the core network operator.

MME 704 may be connected to each of eNodeBs 702 in RAN 604 via an S1 interface and may serve as a control node. For example, MME 704 may be responsible for authenticating users of WTRUs 602, bearer activation or deactivation, selecting a particular serving gateway during an initial attach of WTRUs 602, or the like. MME 704 may also provide a control plane function for switching between RAN 604 and other RANs (not shown) that employ other radio technologies, such as GSM or WCDMA.

Serving gateway 706 may be connected to each of eNodeBs 702 in RAN 604 via the S1 interface. Serving gateway 706 may generally route or forward user data packets to or from the WTRUs 602. Serving gateway 706 may also perform other functions, such as anchoring user planes during inter-eNodeB handovers, triggering paging when downlink data is available for WTRUs 602, managing or storing contexts of WTRUs 602, or the like.

Serving gateway 706 may also be connected to PDN gateway 708, which may provide WTRUs 602 with access to packet-switched networks, such as Internet 610, to facilitate communications between WTRUs 602 and IP-enabled devices.

Core network 606 may facilitate communications with other networks. For example, core network 606 may provide WTRUs 602 with access to circuit-switched networks, such as PSTN 608, such as through IMS core 614, to facilitate communications between WTRUs 602 and traditional land-line communications devices. In addition, core network 606 may provide the WTRUs 602 with access to other networks 612, which may include other wired or wireless networks that are owned or operated by other service providers.

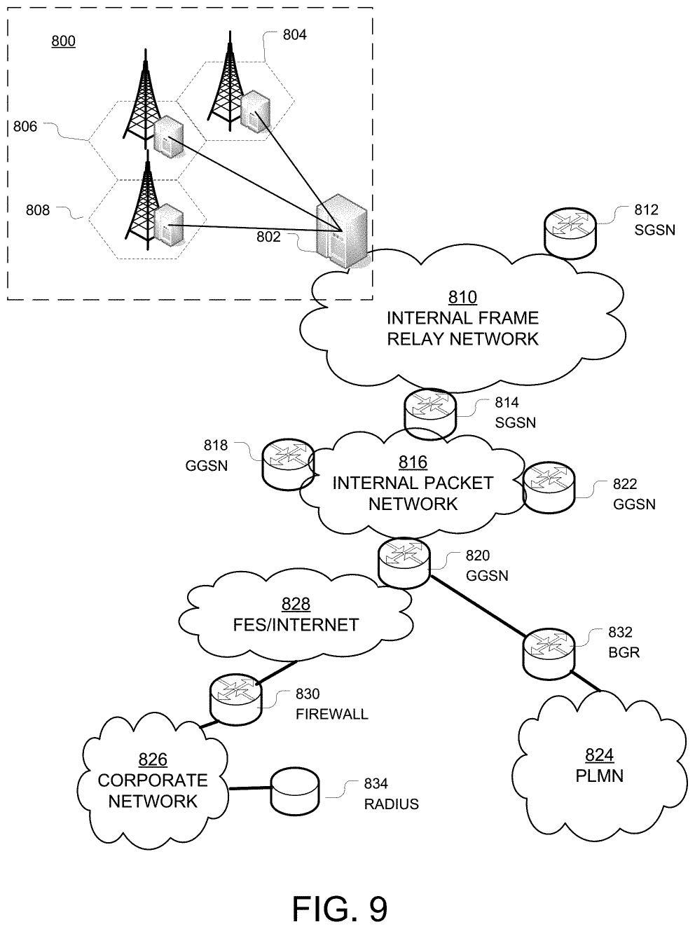

FIG. 9 depicts an overall block diagram of an example packet-based mobile cellular network environment, such as a GPRS network as described herein. In the example packet-based mobile cellular network environment shown in FIG. 9, there are a plurality of base station subsystems (BSS) 800 (only one is shown), each of which comprises a base station controller (BSC) 802 serving a plurality of BTSs, such as BTSs 804, 806, 808. BTSs 804, 806, 808 are the access points where users of packet-based mobile devices become connected to the wireless network. In example fashion, the packet traffic originating from mobile devices is transported via an over-the-air interface to BTS 808, and from BTS 808 to BSC 802. Base station subsystems, such as BSS 800, are a part of internal frame relay network 810 that can include a service GPRS support nodes (SGSN), such as SGSN 812 or SGSN 814. Each SGSN 812, 814 is connected to an internal packet network 816 through which SGSN 812, 814 can route data packets to or from a plurality of gateway GPRS support nodes (GGSN) 818, 820, 822. As illustrated, SGSN 814 and GGSNs 818, 820, 822 are part of internal packet network 816. GGSNs 818, 820, 822 mainly provide an interface to external IP networks such as PLMN 824, corporate intranets/internets 826, or Fixed-End System (FES) or the public Internet 828. As illustrated, subscriber corporate network 826 may be connected to GGSN 820 via a firewall 830. PLMN 824 may be connected to GGSN 820 via a boarder gateway router (BGR) 832. A Remote Authentication Dial-In User Service (RADIUS) server 834 may be used for caller authentication when a user calls corporate network 826.

Generally, there may be a several cell sizes in a network, referred to as macro, micro, pico, femto or umbrella cells. The coverage area of each cell is different in different environments. Macro cells can be regarded as cells in which the base station antenna is installed in a mast or a building above average roof top level. Micro cells are cells whose antenna height is under average roof top level. Micro cells are typically used in urban areas. Pico cells are small cells having a diameter of a few dozen meters. Pico cells are used mainly indoors. Femto cells have the same size as pico cells, but a smaller transport capacity. Femto cells are used indoors, in residential or small business environments. On the other hand, umbrella cells are used to cover shadowed regions of smaller cells and fill in gaps in coverage between those cells.

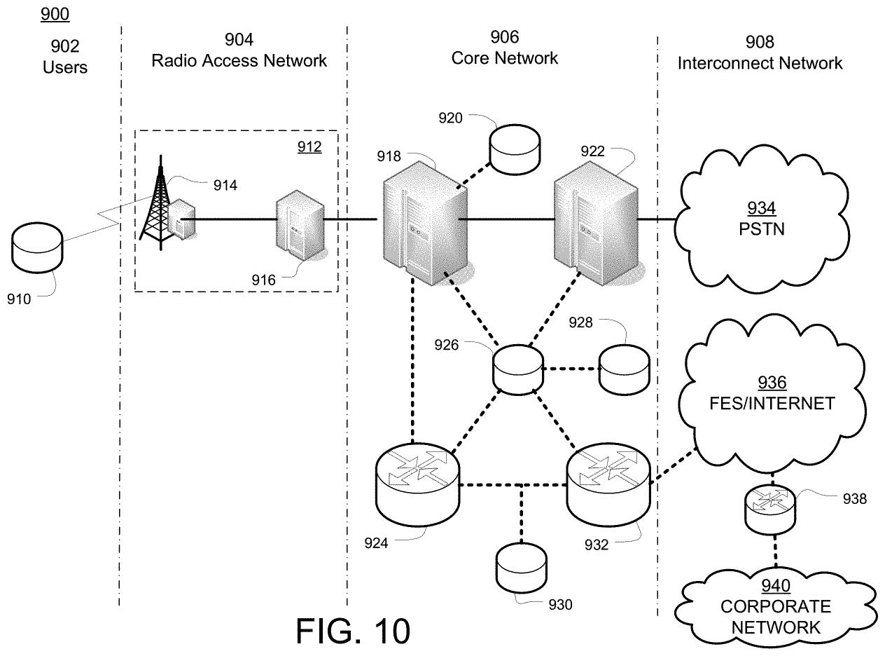

FIG. 10 illustrates an architecture of a typical GPRS network 900 as described herein. The architecture depicted in FIG. 10 may be segmented into four groups: users 902, RAN 904, core network 906, and interconnect network 908. Users 902 comprise a plurality of end users, who each may use one or more devices 910. Note that device 910 is referred to as a mobile subscriber (MS) in the description of network shown in FIG. 10. In an example, device 910 comprises a communications device (e.g., IoT devices 32, mobile positioning center 116, network device 300, any of detected devices 500, second device 508, access device 604, access device 606, access device 608, access device 610 or the like, or any combination thereof). Radio access network 904 comprises a plurality of BSSs such as BSS 912, which includes a BTS 914 and a BSC 916. Core network 906 may include a host of various network elements. As illustrated in FIG. 10, core network 906 may comprise MSC 918, service control point (SCP) 920, gateway MSC (GMSC) 922, SGSN 924, home location register (HLR) 926, authentication center (AuC) 928, domain name system (DNS) server 930, and GGSN 932. Interconnect network 908 may also comprise a host of various networks or other network elements. As illustrated in FIG. 10, interconnect network 908 comprises a PSTN 934, a FES/Internet 936, a firewall 1038, or a corporate network 940.

An MSC can be connected to a large number of BSCs. At MSC 918, for instance, depending on the type of traffic, the traffic may be separated in that voice may be sent to PSTN 934 through GMSC 922, or data may be sent to SGSN 924, which then sends the data traffic to GGSN 932 for further forwarding.

When MSC 918 receives call traffic, for example, from BSC 916, it sends a query to a database hosted by SCP 920, which processes the request and issues a response to MSC 918 so that it may continue call processing as appropriate.

HLR 926 is a centralized database for users to register to the GPRS network. HLR 926 stores static information about the subscribers such as the International Mobile Subscriber Identity (IMSI), subscribed services, or a key for authenticating the subscriber. HLR 926 also stores dynamic subscriber information such as the current location of the MS. Associated with HLR 926 is AuC 928, which is a database that contains the algorithms for authenticating subscribers and includes the associated keys for encryption to safeguard the user input for authentication.

In the following, depending on context, “mobile subscriber” or “MS” sometimes refers to the end user and sometimes to the actual portable device, such as a mobile device, used by an end user of the mobile cellular service. When a mobile subscriber turns on his or her mobile device, the mobile device goes through an attach process by which the mobile device attaches to an SGSN of the GPRS network. In FIG. 10, when MS 910 initiates the attach process by turning on the network capabilities of the mobile device, an attach request is sent by MS 910 to SGSN 924. The SGSN 924 queries another SGSN, to which MS 910 was attached before, for the identity of MS 910. Upon receiving the identity of MS 910 from the other SGSN, SGSN 924 requests more information from MS 910. This information is used to authenticate MS 910 together with the information provided by HLR 926. Once verified, SGSN 924 sends a location update to HLR 926 indicating the change of location to a new SGSN, in this case SGSN 924. HLR 926 notifies the old SGSN, to which MS 910 was attached before, to cancel the location process for MS 910. HLR 926 then notifies SGSN 924 that the location update has been performed. At this time, SGSN 924 sends an Attach Accept message to MS 910, which in turn sends an Attach Complete message to SGSN 924.

Next, MS 910 establishes a user session with the destination network, corporate network 940, by going through a Packet Data Protocol (PDP) activation process. Briefly, in the process, MS 910 requests access to the Access Point Name (APN), for example, UPS.com, and SGSN 924 receives the activation request from MS 910. SGSN 924 then initiates a DNS query to learn which GGSN 932 has access to the UPS.com APN. The DNS query is sent to a DNS server within core network 906, such as DNS server 930, which is provisioned to map to one or more GGSNs in core network 906. Based on the APN, the mapped GGSN 932 can access requested corporate network 940. SGSN 924 then sends to GGSN 932 a Create PDP Context Request message that contains necessary information. GGSN 932 sends a Create PDP Context Response message to SGSN 924, which then sends an Activate PDP Context Accept message to MS 910.

Once activated, data packets of the call made by MS 910 can then go through RAN 904, core network 906, and interconnect network 908, in a particular FES/Internet 936 and firewall 1038, to reach corporate network 940.

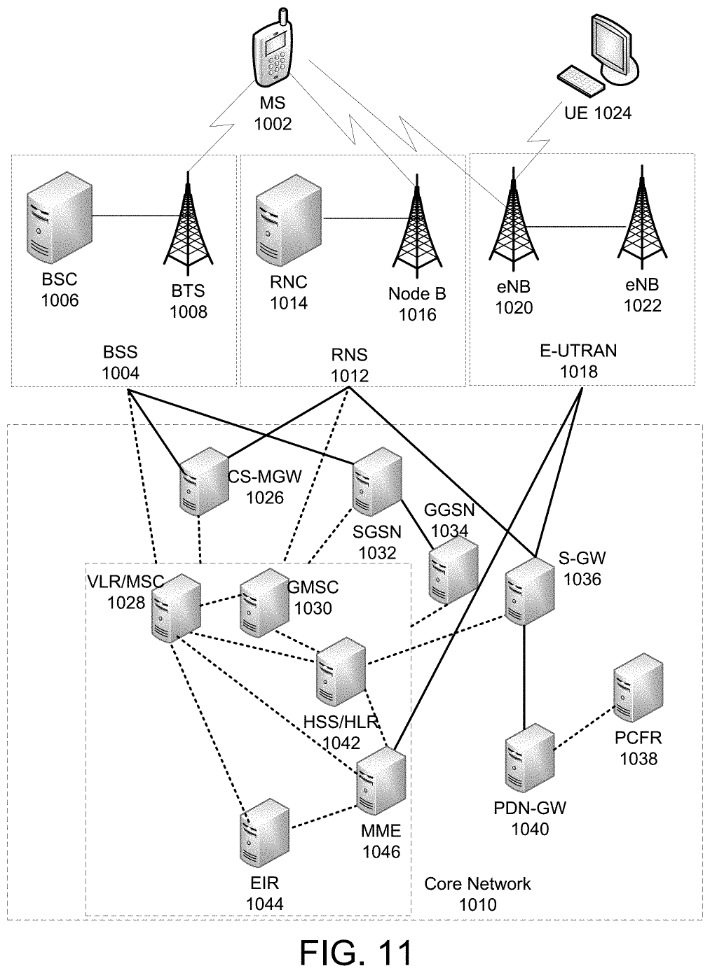

FIG. 11 illustrates a PLMN block diagram view of an example architecture that may be replaced by a telecommunications system. In FIG. 11, solid lines may represent user traffic signals, and dashed lines may represent support signaling. MS 1002 is the physical equipment used by the PLMN subscriber. For example, IoT devices 32, network device 300, the like, or any combination thereof may serve as MS 1002. MS 1002 may be one of, but not limited to, a cellular telephone, a cellular telephone in combination with another electronic device or any other wireless mobile communication device.

MS 1002 may communicate wirelessly with BSS 1004. BSS 1004 contains BSC 1006 and a BTS 1008. BSS 1004 may include a single BSC 1006/BTS 1008 pair (base station) or a system of BSC/BTS pairs that are part of a larger network. BSS 1004 is responsible for communicating with MS 1002 and may support one or more cells. BSS 1004 is responsible for handling cellular traffic and signaling between MS 1002 and a core network 1010. Typically, BSS 1004 performs functions that include, but are not limited to, digital conversion of speech channels, allocation of channels to mobile devices, paging, or transmission/reception of cellular signals.

Additionally, MS 1002 may communicate wirelessly with RNS 1012. RNS 1012 contains a Radio Network Controller (RNC) 1014 and one or more Nodes B 1016. RNS 1012 may support one or more cells. RNS 1012 may also include one or more RNC 1014/Node B 1016 pairs or alternatively a single RNC 1014 may manage multiple Nodes B 1016. RNS 1012 is responsible for communicating with MS 1002 in its geographically defined area. RNC 1014 is responsible for controlling Nodes B 1016 that are connected to it and is a control element in a UMTS radio access network. RNC 1014 performs functions such as, but not limited to, load control, packet scheduling, handover control, security functions, or controlling MS 1002 access to core network 1010.

An E-UTRA Network (E-UTRAN) 1018 is a RAN that provides wireless data communications for MS 1002 and UE 1024. E-UTRAN 1018 provides higher data rates than traditional UMTS. It is part of the LTE upgrade for mobile networks, and later releases meet the requirements of the International Mobile Telecommunications (IMT) Advanced and are commonly known as a 4G networks. E-UTRAN 1018 may include of series of logical network components such as E-UTRAN Node B (eNB) 1020 and E-UTRAN Node B (eNB) 1022. E-UTRAN 1018 may contain one or more eNBs. User equipment (UE) 1024 may be any mobile device capable of connecting to E-UTRAN 1018 including, but not limited to, a personal computer, laptop, mobile device, wireless router, or other device capable of wireless connectivity to E-UTRAN 1018. The improved performance of the E-UTRAN 1018 relative to a typical UMTS network allows for increased bandwidth, spectral efficiency, and functionality including, but not limited to, voice, high-speed applications, large data transfer or IPTV, while still allowing for full mobility.

Typically, MS 1002 may communicate with any or all of BSS 1004, RNS 1012, or E-UTRAN 1018. In an illustrative system, each of BSS 1004, RNS 1012, and E-UTRAN 1018 may provide MS 1002 with access to core network 1010. Core network 1010 may include of a series of devices that route data and communications between end users. Core network 1010 may provide network service functions to users in the circuit switched (CS) domain or the packet switched (PS) domain. The CS domain refers to connections in which dedicated network resources are allocated at the time of connection establishment and then released when the connection is terminated. The PS domain refers to communications and data transfers that make use of autonomous groupings of bits called packets. Each packet may be routed, manipulated, processed, or handled independently of all other packets in the PS domain and does not require dedicated network resources.

The circuit-switched MGW function (CS-MGW) 1026 is part of core network 1010 and interacts with VLR/MSC server 1028 and GMSC server 1030 in order to facilitate core network 1010 resource control in the CS domain. Functions of CS-MGW 1026 include, but are not limited to, media conversion, bearer control, payload processing or other mobile network processing such as handover or anchoring. CS-MGW 1026 may receive connections to MS 1002 through BSS 1004 or RNS 1012.

SGSN 1032 stores subscriber data regarding MS 1002 in order to facilitate network functionality. SGSN 1032 may store subscription information such as, but not limited to, the IMSI, temporary identities, or PDP addresses. SGSN 1032 may also store location information such as, but not limited to, GGSN address for each GGSN 1034 where an active PDP exists. GGSN 1034 may implement a location register function to store subscriber data it receives from SGSN 1032 such as subscription or location information.

Serving gateway (S-GW) 1036 is an interface which provides connectivity between E-UTRAN 1018 and core network 1010. Functions of S-GW 1036 include, but are not limited to, packet routing, packet forwarding, transport level packet processing, or user plane mobility anchoring for inter-network mobility. PCRF 1038 uses information gathered from P-GW 1036, as well as other sources, to make applicable policy and charging decisions related to data flows, network resources or other network administration functions. PDN gateway (PDN-GW) 1040 may provide user-to-services connectivity functionality including, but not limited to, GPRS/EPC network anchoring, bearer session anchoring and control, or IP address allocation for PS domain connections.

HSS 1042 is a database for user information and stores subscription data regarding MS 1002 or UE 1024 for handling calls or data sessions. Networks may contain one HSS 1042 or more if additional resources are required. Example data stored by HSS 1042 include, but is not limited to, user identification, numbering or addressing information, security information, or location information. HSS 1042 may also provide call or session establishment procedures in both the PS and CS domains.

VLR/MSC Server 1028 provides user location functionality. When MS 1002 enters a new network location, it begins a registration procedure. An MSC server for that location transfers the location information to the VLR for the area. A VLR and MSC server may be located in the same computing environment, as is shown by VLR/MSC server 1028, or alternatively may be located in separate computing environments. A VLR may contain, but is not limited to, user information such as the IMSI, the Temporary Mobile Station Identity (TMSI), the Local Mobile Station Identity (LMSI), the last known location of the mobile station, or the SGSN where the mobile station was previously registered. The MSC server may contain information such as, but not limited to, procedures for MS 1002 registration or procedures for handover of MS 1002 to a different section of core network 1010. GMSC server 1030 may serve as a connection to alternate GMSC servers for other MSs in larger networks.

EIR 1044 is a logical element which may store the IMEI for MS 1002. User equipment may be classified as either “white listed” or “blacklisted” depending on its status in the network. If MS 1002 is stolen and put to use by an unauthorized user, it may be registered as “blacklisted” in EIR 1044, preventing its use on the network. An MME 1046 is a control node which may track MS 1002 or UE 1024 if the devices are idle. Additional functionality may include the ability of MME 1046 to contact idle MS 1002 or UE 1024 if retransmission of a previous session is required.

While examples of described telecommunications system have been described in connection with various computing devices/processors, the underlying concepts may be applied to any computing device, processor, or system capable of facilitating a telecommunications system. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes a device for telecommunications. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language and may be combined with hardware implementations.

The methods and devices associated with a telecommunications system as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an device for implementing telecommunications as described herein. When implemented on a general-purpose processor, the program code combines with the processor to provide a unique device that operates to invoke the functionality of a telecommunications system.

While a telecommunications system has been described in connection with the various examples of the various figures, it is to be understood that other similar implementations may be used, or modifications and additions may be made to the described examples of a telecommunications system without deviating therefrom. For example, one skilled in the art will recognize that a telecommunications system as described in the instant application may apply to any environment, whether wired or wireless, and may be applied to any number of such devices connected via a communications network and interacting across the network. Therefore, a telecommunications system as described herein should not be limited to any single example, but rather should be construed in breadth and scope in accordance with the appended claims.

Methods, systems, and apparatuses as disclosed herein may provide for receiving an indication of an origin node and a destination node for a service; receiving an indication of a plurality of paths from the origin node to the destination node, wherein the plurality of paths comprise a plurality of nodes; receiving an indication of one or more functions used for the service; determining one or more nodes of the plurality of nodes that can operate or generate the one or more functions used for the service; determining one or more operational positions for each of the one or more functions on one or more nodes of the plurality of nodes; providing instructions to generate or operate the one or more functions on the one or more operational positions; and sending messages for the service from the origin node to the destination node through a path comprising the one or more operational positions. The determining one or more optimal positions may be based on a comparison of information associated with the plurality of nodes, the information comprising transport cost information, operational cost for hosting a function, capacity information, feature information, or functionality information. There may be instructions provided to send a function table that comprises current or proposed locations of the functions and the corresponding one or more nodes of the plurality of nodes. The message may include instructions to move the function from one operational position of the one or more operational positions to another operational position of the one or more operational positions. The determining one or more operational positions for each of the one or more functions on the one or more nodes may include determining whether the function can operate on each of the one or more nodes in conjunction with functions already residing on each of the one or more nodes. The determining one or more operational positions for each of the one or more functions on the one or more nodes may include using a scout to simulate operation of the function on each of the one or more nodes. The scout may be a container or virtual machine (VM). A scout may be stored on each node of the one or more nodes. All combinations of the aforementioned subject matter are contemplated.

1. A device, the device comprising:
a processor; and
a memory coupled with the processor, the memory storing executable instructions that when executed by the processor, cause the processor to effectuate operations comprising:
receiving an indication of an origin node and a destination node for a service;
receiving an indication of a plurality of paths from the origin node to the destination node, wherein the plurality of paths comprise a plurality of nodes;
receiving an indication of one or more functions used for the service;
determining one or more nodes of the plurality of nodes that can operate or generate the one or more functions used for the service;
determining one or more operational positions for each of the one or more functions on one or more nodes of the plurality of nodes;
providing instructions to generate or operate the one or more functions on the one or more operational positions; and
sending messages for the service from the origin node to the destination node through a path comprising the one or more operational positions.

2. The device of claim 1, wherein the determining one or more optimal positions is based on a comparison of information associated with the plurality of nodes, the information comprising transport cost information, operational cost for hosting a function, capacity information, feature information or functionality information.

3. The device of claim 1, wherein the processor further effectuates operations comprising providing instructions to send a function table that comprises current or proposed locations of the functions and the corresponding one or more nodes of the plurality of nodes.

4. The device of claim 1, further operations comprising sending messages that comprise instructions to move a function of the one or more functions from one operational position of the one or more operational positions to another operational position of the one or more operational positions.

5. The device of claim 1, wherein determining one or more operational positions for each of the one or more functions on the one or more nodes comprises determining whether the one or more functions can operate on each of the one or more nodes in conjunction with functions already residing on each of the one or more nodes.

6. The device of claim 1, wherein determining one or more operational positions for each of the one or more functions on the one or more nodes comprises using a scout to simulate operation of a function on each of the one or more nodes.

7. The device of claim 6, wherein the scout is a container or virtual machine (VM).

8. The device of claim 1, wherein a scout is stored on each node of the one or more nodes.

9. A computer-implemented method comprising:
receiving an indication of an origin node and a destination node for a service;
receiving an indication of a plurality of paths from the origin node to the destination node, wherein the plurality of paths comprise a plurality of nodes;
receiving an indication of one or more functions used for the service;
determining one or more nodes of the plurality of nodes that can operate or generate the one or more functions used for the service;
determining one or more operational positions for each of the one or more functions on one or more nodes of the plurality of nodes;
providing instructions to generate or operate the one or more functions on the one or more operational positions; and
sending messages for the service from the origin node to the destination node through an optimal path comprising the one or more operational positions.

10. The computer-implemented method of claim 9, wherein the determining one or more optimal positions is based on a comparison of information associated with the plurality of nodes, the information comprising transport cost information, operational cost for hosting a function, capacity information, feature information or functionality information.

11. The computer-implemented method of claim 9, further comprising providing instructions to send a function table that comprises current or proposed locations of the functions and the corresponding one or more nodes of the plurality of nodes.

12. The computer-implemented method of claim 9, further comprising sending messages that comprise instructions to move the one or more functions from one operational position of the one or more operational positions to another operational position of the one or more operational positions.

13. The computer-implemented method of claim 9, wherein determining one or more operational positions for each of the one or more functions on the one or more nodes comprises determining whether the one or more functions can operate on each of the one or more nodes in conjunction with functions already residing on each of the one or more nodes.

14. The computer-implemented method of claim 9, wherein determining one or more operational positions for each of the one or more functions on the one or more nodes comprises using a scout to simulate operation of the one or more functions on each of the one or more nodes.

15. The computer-implemented method of claim 14, wherein the scout is a container or virtual machine (VM).

16. The computer-implemented method of claim 9, wherein a scout is stored on each node of the one or more nodes.

17. A computer-readable storage medium storing executable instructions that when executed by a computing device cause said computing device to effectuate operations comprising:
receiving an indication of an origin node and a destination node for a service;
receiving an indication of a plurality of paths from the origin node to the destination node, wherein the plurality of paths comprise a plurality of nodes;
receiving an indication of one or more functions used for the service;
determining one or more nodes of the plurality of nodes that can operate or generate the one or more functions used for the service;
determining one or more operational positions for each of the one or more functions on one or more nodes of the plurality of nodes;
providing instructions to generate or operate the one or more functions on the one or more operational positions; and
sending messages for the service from the origin node to the destination node through an optimal path comprising the one or more operational positions.

18. The computer-readable storage medium of claim 17, wherein the determining one or more optimal positions is based on a comparison of information associated with the plurality of nodes, the information comprising transport cost information, operational cost for hosting a function, capacity information, feature information or functionality information.

19. The computer-readable storage medium of claim 17, wherein determining one or more operational positions for each of the one or more functions on the one or more nodes comprises determining whether the one or more functions can operate on each of the one or more nodes in conjunction with functions already residing on each of the one or more nodes.

20. The computer-readable storage medium of claim 17, wherein determining one or more operational positions for each of the one or more functions on the one or more nodes comprises using a scout to simulate operation of the one or more functions on each of the one or more nodes.
